(19) United States
(12) Patent Application Publication
(10) Pub. No.: US 2014/0331078 A1
(43) Pub. Date: Nov. 6, 2014

(54) Elastic Space-Based Architecture application system for a cloud computing environment

(71) Applicant: Uri Cohen, Hod Hasharon (IL)

(72) Inventor: Uri Cohen, Hod Hasharon (IL)

(21) Appl. No.: 13/749,240

(22) Filed: Jan. 24, 2013

(51) Int. Cl. H04L 29/08; G06F 11/20

(52) U.S. Cl. CPC H04L 67/10; G06F 11/2007; G06F 2201/805
USPC 714/4.11; 709/201

(57) ABSTRACT

A software architecture and infrastructure to seamlessly scale mission-critical, high performance, stateful enterprise applications on any cloud environment (public as well as private). The described invention will allow converting an application to a scalable application and will provide a method and a system to efficiently scale up the performance of such an application based on space-based architecture.

### CROSS-REFERENCE TO RELATED APPLICATIONS

This application claims the benefit of priority from U.S. Provisional Patent Application No. 61/590,823, filed on Dec. 26, 2012.

### BACKGROUND OF THE INVENTION

In many application domains today, especially in financial services, the number of clients, the depth of services provided, and the data volumes are all growing simultaneously; in parallel, middle-office analytics applications are moving towards near-real-time processing. As a result, application workload is growing exponentially. One GigaSpaces™ customer is expecting to grow from 100K trades to 80 million trades—in only two years!

In order to understand the scalability problem, we must first define scalability: scalability is the ability to grow an application to meet growing demand, without changing the code, and without sacrificing the data affinity and service levels demanded by your users.

We identify two situations in which scalability is interrupted:

A scalability crash barrier—occurs if your application, as it is today, cannot scale up without reducing data affinity or increasing latency to unacceptable levels.

A marginal cost barrier—occurs when the cost of scaling your application progressively increases, until scaling further is not economically justifiable.

Examples for such problems are cluster nodes which get overloaded by inefficient clustering; different clustering models for each tier cause unnecessary ping-pong inside the tiers; unknown scaling ratios between system components cause unexpected bottlenecks when the system scales; growing messaging volumes might overload the processing components; the network becomes the bottleneck; inability to virtualize the tiers causes coordination problems; and different WA models for each tier makes it difficult to guarantee recovery from partial failure.

Space-based architecture is a method to build applications which are fully scalable. Per Wikipedia “With a space-based architecture, applications are built out of a set of self-sufficient units, known as processing-units (PU). These units are independent of each other, so that the application can scale by adding more units.

Traditionally transaction processing is dealing with very large amounts of data, accessed over networks. They used a tier based architecture for processing.

The space-based architecture processing units are dealing with small amounts of data, the information communication is done via local memory and there is a content based routing to get to these units.

### SUMMARY OF THE INVENTION

Plain SBA is designed to scale stateful applications on traditional, non-virtualized data centers. Elastic SBA extends it by allowing the SBA application to leverage the dynamicity of virtualized and cloud environments. Based on real time performance and utilization metrics, it can provision additional virtual servers and allow the application to dynamically increase the application's capacity by leveraging these servers. Or vice versa, it can bring down existing virtual servers which are under-utilized to save costs and resources.

### BRIEF DESCRIPTION OF THE DRAWINGS

FIG. 1 is an overall system diagram.

FIG. 2 is a description of applications under SBA architecture.

FIG. 3 is a description of system metrics.

FIG. 4 is a description of the scaling platform.

FIG. 5 is a flow chart of the scaling platform.

### DETAILED DESCRIPTION OF THE INVENTION

The purpose of the invention is to get to a scalable system, which can linearly add computing power to achieve more performance.

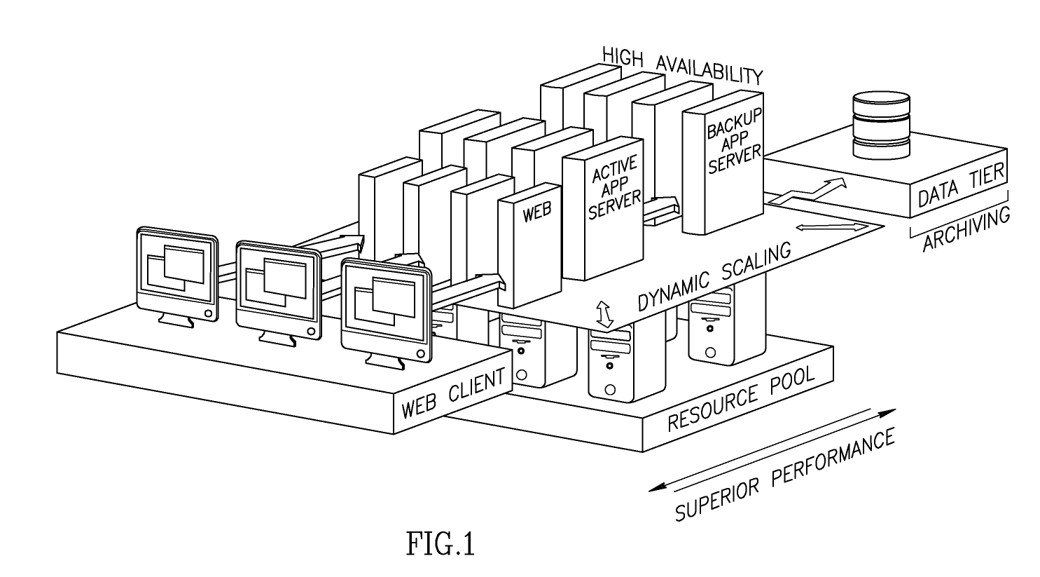

FIG. 1 is showing the overall system diagram where internet request are being handled by active servers with a backup of backup servers and a dynamic scaling platform is using the resource pool to provide the right amount of virtual servers.

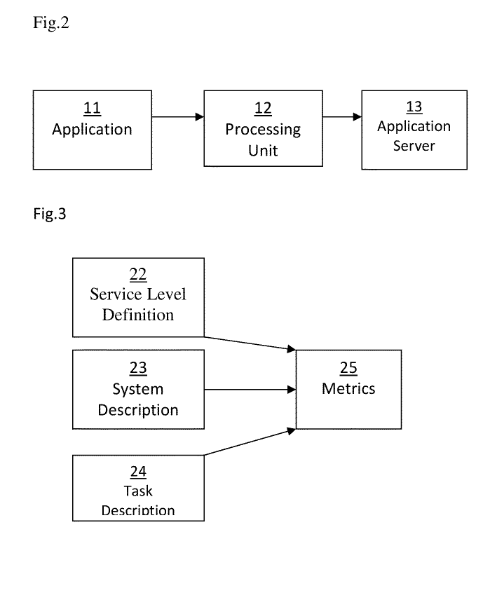

The first step described in FIG. 2, is to convert existing standard application 11 to SBA processing units 12. This is done by manually converting the application to processing units 12 which deal with specific events, small amounts of data and data reference via local memory. It is possible to have a review tool which will go over the generated processing units and will verify that they adhere to the SBA rules—small data size, simple event handling, local memory data references.

Once processing units are established, they will be wrapped inside a virtual 13 server, which will handle the events and provide other required system services. Potentially, there will be an active server and a backup server. The backup server will run on the same data and will provide the results if the active server fails.

The second step described in FIG. 3 is to develop a performance measurement metrics 24 based on the required service level 21, the task description 22 and the system description 23.

A service level may be the number of transactions per minute, and a performance metrics may be the number of executed instructions in a second. It will be per type of event (e.g. customer bank account transactions). The performance metrics will not be for a single server or processing unit, but for all servers. Based on the provided input information, a window will be defined—that if the metrics is below a certain threshold more servers will be required and if it is above a certain threshold less are required. The metrics will change as the service level requirement and the system description may change.

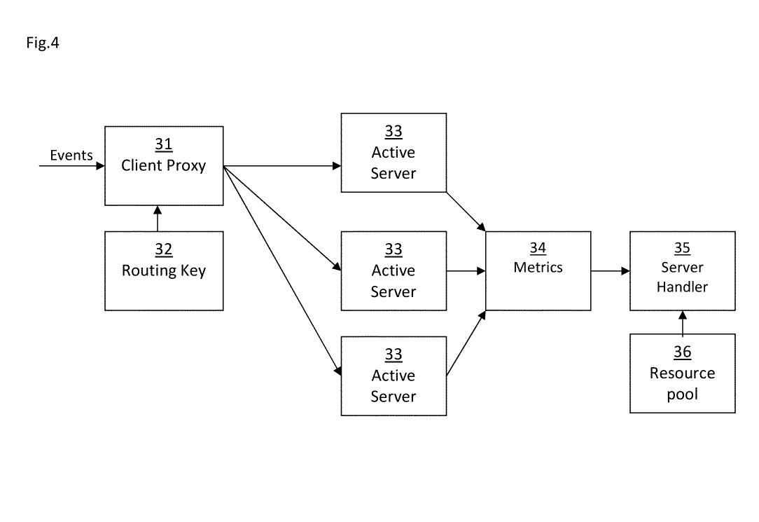

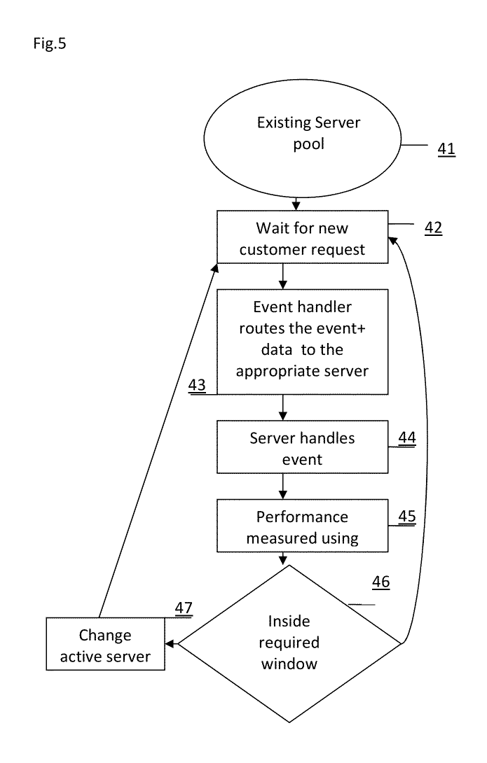

The dynamic scaling platform described in FIG. 4 will handle the servers and decide on the right amount of servers required per event handling (a different processing unit may be required per event).

Customer request are causing events. Events can also be caused by software tasks running There may be different types of events (e.g. deposit, sell shares). Each such event will be handled by a different type of processing units inside server. The events will be emitted by a client proxy 31, which will rout them to the right server. The routing will be done based the routing key 32, which will take into account the type of event and the number of events which each processing unit can handle. (There can be a processing unit per bank account or per 1000 bank accounts).

The event will be routed to the active servers 32 with backup servers running for backup.

The active server will process the event, and if they crash the backup servers will step instead.

The active servers will be monitored by the system metrics 34, which will provide the information to the server handler 35, which based on the metrics and the available resource pool 36 will decide on the right number of active servers for this task.

FIG. 5 describes the flow chart of the scaling platform. It starts with a given server pool in step 41.

In step 42 it will wait for a customer request or for any other event.

In step 43 the proxy will rout the coming event together with the required data to the right active server and backup server.

In step 44 the server will process the event.

In step 45 the performance will be measured using the metrics. Such measurement will be taken on all servers handling this type of event, which will give an overall metrics for this event handling.

In step 46 the metrics will be compared against it's performance window.

If yes, inside the window, it will just go back to step 42 and wait for next event.

If no, it will adjust the number of servers for this task—increase or decrease them.

The describes system and method enable linear performance increase with resource allocation without any waste for unnecessary resources.

What is claimed is:

1. A system where business applications are converted to SBA processing units which are reviewed for SBA adherence by a tool.

2. A system as in claim 1 where a virtual active server is created for running an SBA processing unit

3. A system as in claim 2 where a back up server is created for running an SBA processing unit, the back up server will provide the required results if the active server fails.

4. A data center system where a performance metrics is being created per business application based on the application required service level.

5. A data center system as in claims 4 and 2 where per the performance metrics the appropriate number of active servers is being activated
